(19) United States
(12) Patent Application Publication
(10) Pub. No.: US 2018/0211599 A1
(43) Pub. Date: Jul. 26, 2018

(54) PIXEL CIRCUIT, DRIVING METHOD FOR THE SAME AND AN ORGANIC LIGHT-EMITTING DISPLAY

(71) Applicant: Wuhan China Star Optoelectronics Technology Co., Ltd., Wuhan, Hubei (CN)

(72) Inventors: Jun LI, Shenzhen, Guangdong (CN); Di ZHANG, Shenzhen, Guangdong (CN)

(73) Assignee: Wuhan China Star Optoelectronics Technology Co., Ltd., Wuhan, Hubei (CN)

(21) Appl. No.: 15/327,975

(22) PCT Filed: Dec. 26, 2016
(86) PCT No.: PCT/CN2016/112172

§ 371 Date: Jan. 20, 2017

(30) Foreign Application Priority Data
Dec. 2, 2016 (CN) 201611095291.2

(51) Int. Cl. G09G 3/3258

(52) U.S. Cl. CPC G09G 3/3258; G09G 2310/061; G09G 2300/0819; G09G 2300/043

(57) ABSTRACT

A pixel circuit, driving method for the same and an organic light-emitting display are provided. The pixel circuit includes: a resetting module transmitting a reset voltage to a compensation module under the control of the first control signal; the compensation module compensating a threshold voltage under the control of the second control signal; a writing module transmitting a data signal to the compensation module under the control of the third control signal; and a light-emitting module emitting light under the control of a light-emitting control signal. The present invention can eliminate a bad display problem caused by the drift of the threshold voltage of a driving TFT.

### BACKGROUND OF THE INVENTION

### 1. Field of the Invention

The present invention application relates to a display technology field, and more particularly to a pixel circuit, driving method for the same and an organic light-emitting display.

### 2. Description of Related Art

An organic light-emitting diode (OLED) has wide color gamut, high contrast ratio, power saving and foldable such that the OLED has strong competitiveness in new generation displays. Active matrix organic light-emitting diode (AMOLED) is main development direction of flexible display.

The basic driving circuit for AMOLED is shown in FIG. 1, which is a 2T1C mode, that is, including two thin-film transistors (TFT) and a capacitor. Specifically, including a switching TFT T1, a driving TFT T2 and a storage capacitor Cst. A driving current of an OLED is controlled by the driving TFT T2, and the current of the driving TFT T2 is: I_{OLED}=k(V_{gs}−Vₜₕ)² , wherein, k is a current amplification coefficient of the driving TFT T2, and is decided by the property of the driving TFT T2 itself; Vth is a threshold voltage of the driving TFT T2. Because of long time operation, the threshold voltage Vth of the deriving TFT T2 will drift so that the driving current of the OLED is changed such that the OLED panel is abnormal and affecting the display quality.

### SUMMARY OF THE INVENTION

The basic driving circuit for AMOLED does not have a threshold voltage Vth compensation function, which will affect the product property. Therefore, the present invention provides an all P-type pixel circuit capable of compensating the drift of the threshold voltage in order to improve the display property of AMOLED.

The embodiment of the present invention provides a pixel circuit, comprising: a resetting module, wherein a control terminal of the resetting module receives a first control signal, the other two terminals of the resetting module are respectively connected to a reset voltage terminal and the compensation module, the reset voltage terminal has a reset voltage, the resetting module transmits the reset voltage to the compensation module under the control of the first control signal; a compensation module, wherein the compensation module receives a second control signal and a first voltage from a first voltage terminal, the compensation module is respectively connected to the resetting module, the writing module and the light-emitting module, the compensation module performs compensation for a threshold voltage under the control of the second control signal; writing module, wherein a control terminal of the writing module receives a third control signal, an input terminal of the writing module is connected with a data signal terminal and receives a data signal from the data signal terminal, an output terminal of the writing module is connected to the compensation module, the writing module transmits the data signal to the compensation module under the control of the third control signal; and a light-emitting module, wherein a terminal of the light-emitting module is connected to a second voltage terminal and receives a second voltage from the second voltage terminal, another terminal of the light-emitting module is connected to the compensation module, a control terminal of the light-emitting module receives a light-emitting control signal, the light-emitting module emits light under the control of the light-emitting control signal.

The pixel circuit according to the embodiment of the present invention, wherein, the resetting module includes a fifth TFT, a gate of the fifth TFT receives the first control signal, a drain of the fifth TFT is connected to the compensation module, a source of the fifth TFT receives the reset voltage VI, and the fifth TFT outputs the reset voltage to the compensation module under the control of the first control signal.

The pixel circuit according to the embodiment of the present invention, ii wherein, the compensation module includes a first TFT, a third TFT, a fourth TFT, a first capacitor and a second capacitor; a gate of the first TFT is connected to the resetting module, a source of the first TFT receives a first voltage, a drain of the first TFT is connected to the light-emitting module; a gate of the third TFT receives the second control signal, a source of the third TFT receives the first voltage, and a drain of the third TFT is connected to the writing module; a gate of the fourth TFT is connected to the second control signal, a source and a drain of the fourth TFT are respectively connected to a drain and a gate of the first TFT; two terminals of the first capacitor are respectively connected to the first voltage terminal and the writing module; two terminals of the second capacitor are respectively connected to the writing module and the gate of the first TFT; under the control of the second control signal, the first TFT, the third TFT, and the fourth TFT are conductive, and the second capacitor records a threshold voltage Vth of the first TFT.

The pixel circuit according to the embodiment of the present invention, wherein, the writing module includes a second TFT; a gate of the second TFT receives the third control signal, a source of the second TFT is connected to the data input terminal, and a drain of the second TFT is connected to the compensation module; the second TFT is conductive under the control of the third control signal, and outputs a data voltage of the data signal to the compensation module.

The pixel circuit according to the embodiment of the present invention, wherein, the light-emitting module includes a sixth TFT and an organic light-emitting diode; a gate of the sixth TFT receives the light-emitting control ii signal, a source of the sixth TFT is connected to the compensation module, a drain of the sixth TFT is connected to the organic light-emitting diode; one terminal of the light-emitting diode is connected to the drain of the sixth TFT, and the other terminal of the light-emitting diode is connected to the second voltage terminal; under the control of the light-emitting control signal, the sixth TFT is conductive so that the organic light-emitting diode is conductive to emit light.

The pixel circuit according to the embodiment of the present invention, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

The embodiment of the present invention also provides a driving method adopting the above pixel circuit, the method comprises: in a reset stage, setting the first control signal at a low voltage level so that the fifth TFT is conductive, and the fifth TFT outputs the reset voltage to the gate of the first TFT, and the gate of the first TFT is reset to be the reset voltage; in a compensation stage for the threshold voltage, setting the second control signal at a low voltage level, and the first TFT, the third TFT and the fourth TFT are conductive, wherein the first voltage charges the gate of the first TFT through the first TFT and the fourth TFT until the voltage of the gate of the first TFT rises up to VDD−|Vth|, and the second capacitor records a voltage value of the threshold voltage of the first TFT, wherein VDD is the first voltage and Vth is the threshold voltage of the first TFT; in a data signal writing stage, setting the third control signal at a low voltage level so that the second TFT is conductive, the data voltage is outputted through ii the drain of the second TFT, the first capacitor record the data voltage, the voltage at the gate of the first TFT becomes Vdata−|Vth| through the second capacitor, wherein Vdata is the data voltage; and in a light-emitting stage, setting the light-emitting control signal at a low voltage level, the first TFT and the sixth TFT being conductive, and the organic light-emitting diode emitting light.

The driving method according to the embodiment of the present invention, wherein the reset voltage and the second voltage are at a low voltage level, and the first voltage is at a high voltage level.

The driving method according to the embodiment of the present invention, providing an organic light-emitting display including the above pixel circuit.

### BRIEF DESCRIPTION OF THE DRAWINGS

The flowing will combine the figures to illustrate the exemplary embodiments; the preset invention will become clear and better to be understood in these and/or other aspects:

FIG. 1 is a schematic diagram of a pixel circuit according to a conventional art;

FIG. 2 is a block diagram of a pixel circuit according to an embodiment of the present invention;

FIG. 3 is a specific circuit diagram of a pixel circuit according to an embodiment of the present invention;

FIG. 4 is a timing diagram of control signals of the pixel circuit shown in FIG. 3; and

FIG. 5 is a simulation result of the pixel circuit according to an embodiment of the present invention.

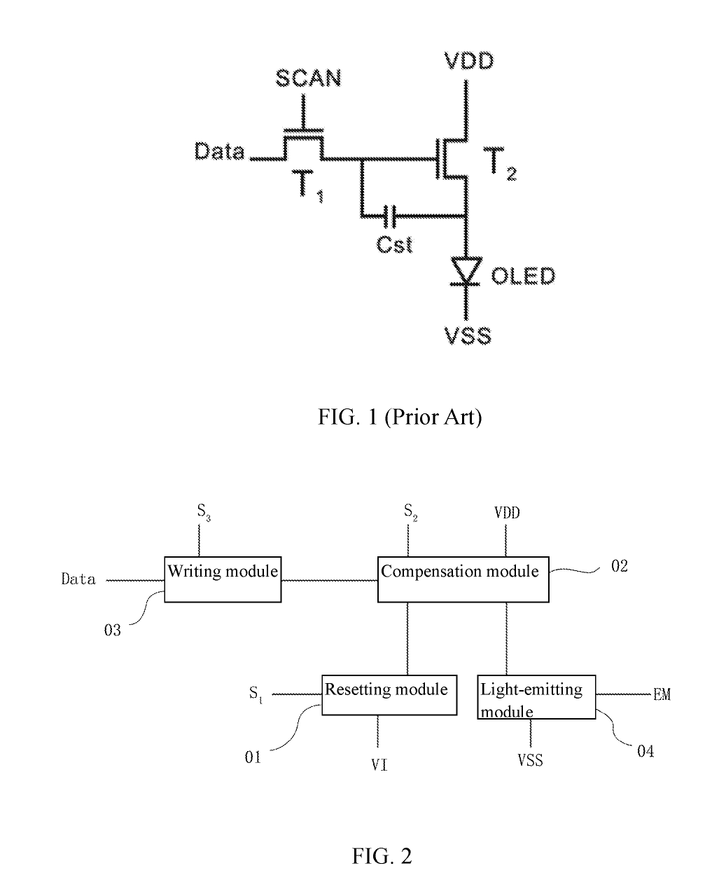

### DETAILED DESCRIPTION OF THE PREFERRED EMBODIMENT

The following will combine figures to illustrate the pixel circuit provided by the embodiments of the present in detail.

FIG. 2 is a block diagram of a pixel circuit according to an embodiment of the present invention. The embodiment of the present invention provides a pixel circuit, and the pixel circuit includes: a resetting module 01, a compensation module 02, a writing module 03 and a light-emitting module 04.

A control terminal of the resetting module 01 receives a first control signal S1; the other two terminals of the resetting module 01 are respectively connected to a reset voltage terminal and the compensation module 02. The reset voltage terminal has a reset voltage VI. The resetting module 01 can transmit the reset voltage VI to the compensation module 02 under the control of the first control signal S1. Wherein, the reset voltage VI is a low voltage.

The compensation module 02 receives a second control signal S2 and a first voltage VDD from a first voltage terminal, and the compensation module 02 is respectively connected to the resetting module 01, the writing module 03 and the light-emitting module 04. The compensation module 02 performs compensation for a threshold voltage under the control of the second control signal S2. Wherein, the first voltage VDD is a high voltage.

A control terminal of the writing module 03 receives a third control signal S3, an input terminal of the writing module 03 is connected with a data signal terminal and receives a data signal Data from the data signal terminal, and an output terminal of the writing module 03 is connected to the compensation ii module 02. The writing module 03 transmits the data signal Data to the compensation module 02 under the control of the third control signal S3.

A terminal of the light-emitting module 04 is connected to a second voltage terminal and receives a second voltage VSS from the second voltage terminal. Another terminal of the light-emitting module 04 is connected to the compensation module 02, and a control terminal of the light-emitting module 04 receives a light-emitting control signal EM. The light-emitting module 04 emits light under the control of the light-emitting control signal EM, Wherein, the second voltage VSS is a low voltage.

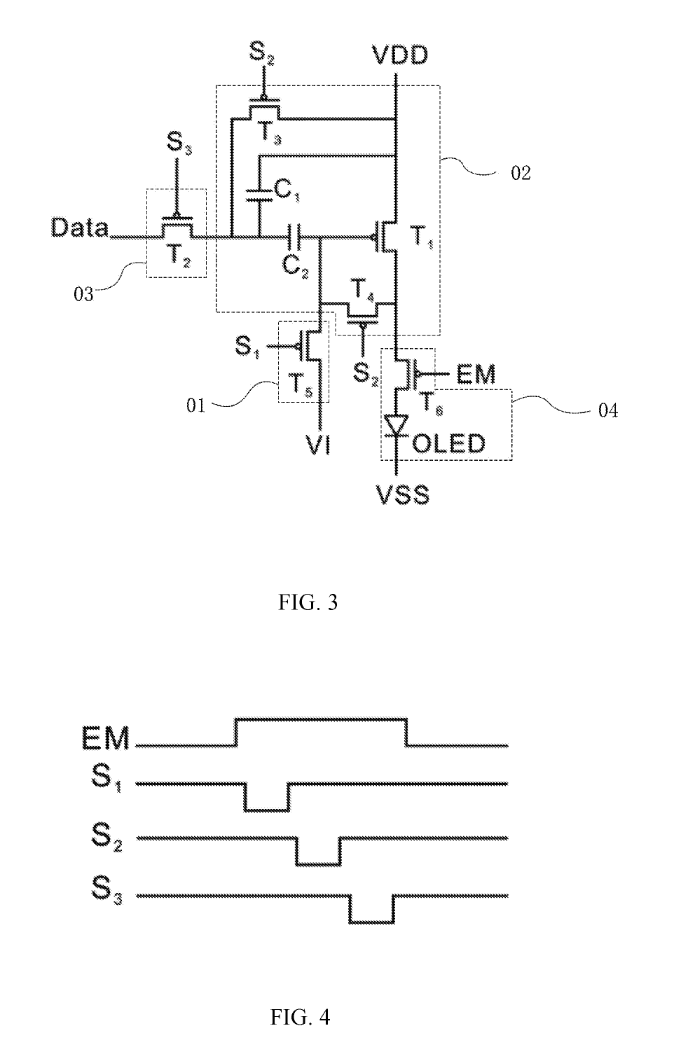

FIG. 3 is a specific circuit diagram of a pixel circuit according to an embodiment of the present invention.

As shown in FIG. 3, the pixel circuit includes six TFT and two capacitors, wherein, T1 is a driving TFT and T2-T5 are switching TFT.

The resetting module 01 includes a fifth TFT T5, a gate of the fifth TFT T5 receives the first control signal S1, a drain of the fifth TFT T5 is connected to the compensation module 02, a source of the fifth TFT T5 receives the reset voltage VI. The fifth TFT T5 is conductive under the control of the first control signal S1 in order to output the reset voltage VI to the compensation module 02.

The compensation module 02 includes a first TFT T1, a third TFT T3, a fourth TFT T4, a first capacitor C1 and a second capacitor C2. A gate of the first TFT Ti is connected to the resetting module 01, a source of the first TFT T1 receives a first voltage VDD, a drain of the first TFT T1 is connected to the light-emitting module 04. A gate of the third TFT T3 receives the second control signal S2, a source of the third TFT T3 receives the first voltage VDD, and a ii drain of the third TFT T3 is connected to the writing module 03. A gate of the fourth TFT T4 is connected to the second control signal S2, a source and a drain of the fourth TFT T4 are respectively connected to a drain and a gate of the first TFT T1. Two terminals of the first capacitor C1 are respectively connected to the first voltage terminal and the writing module 03. Two terminals of the second capacitor C2 are respectively connected to the writing module 03 and the gate of the first TFT. Under the control of the second control signal S2, the first TFT T1, the third TFT T3, and the fourth TFT T4 are conductive, and the second capacitor C2 records a threshold voltage Vth of the first TFT T1.

The writing module 03 includes a second TFT T2. A gate of the second TFT T2 receives the third control signal S3, a source of the second TFT T2 is connected to the data input terminal, and a drain of the second TFT T2 is connected to the compensation module 02. The second TFT T2 is conductive under the control of the third control signal S3, and outputs a data voltage Vdata of the data signal Data to the compensation module 02.

The light-emitting module 04 includes a sixth TFT T6 and an organic light-emitting diode OLED. A gate of the sixth TFT T6 receives the light-emitting control signal EM, a source of the sixth TFT T6 is connected to the compensation module 02, a drain of the sixth TFT T6 is connected to the organic light-emitting diode OLED. One terminal of the light-emitting diode OLED is connected to the drain of the sixth TFT T6, and the other terminal of the light-emitting diode OLED is connected to the second voltage terminal. Under the control of the light-emitting control signal EM, the sixth TFT T6 is conductive so that the organic light-emitting diode OLED is conductive to emit light.

Preferably, each of the first TFT T1, the second TFT T2, the third TFT T3, the fourth TFT T4, the fifth TFT T5 and the sixth TFT T6 is a P-type TFT. Accordingly, when the control signals are at low voltage levels, corresponding thin-film transistors are conductive. Of course, when actually designing the circuit, the thin-film transistors in the specific embodiments of the present invention can also adopt N-type thin-film transistors or a combination of N-type thin-film transistor and P-type thin-film transistor. Besides, the functions of the sources and the drains of the thin-film transistors can be changed according to different types of the thin-film transistor being adopted and different signals at the signal terminals, and the present invention is not limited.

FIG. 4 is a timing diagram of control signals of the pixel circuit shown in FIG. 3. The following content will combine the pixel circuit shown in FIG. 3 and the timing diagram of the control signals shown in FIG. 4 to illustrate the operation principle of the pixel circuit according to the embodiment of the present invention. The operation process of the pixel circuit can be divided into four stages: a rest stage for the gate of the driving TFT, a compensation stage for the threshold voltage, a data signal writing stage for and a light-emitting stage. Specifically illustrated as following:

The first stage is a reset stage for the gate of the driving TFT T1. In the first stage, setting the first control signal at a low voltage level, the second control signal S2, the third control signal S3 and the light-emitting signal EM at a high voltage level. At this time, the fifth TFT T5 is conductive, and the other TFTs are turned off The reset voltage VI received from the source of the fifth TFT T5 is outputted through the drain of the fifth TFT T5. The gate of the first TFT T1 and the drain of the fifth TFT T5 are connected so that the gate of the first TFT T1 is reset to be lower.

The second stage is a compensation stage for the threshold voltage. In the second stage, setting the second control signal S2 at a low voltage level, the first control signal S1, the third control signal S3 and the light-emitting control signal EM at a high voltage level. The first TFT T1, the third TFT T3 and the fourth TFT T4 are conductive, and the other TFTs are turned off. At this time, because the third TFT T3 is conductive, two terminals of the first capacitor C1 are both connected to the first voltage VDD, and voltages at two terminals of the first capacitor C1 are both VDD.

At this time, a left terminal of the second capacitor C2 is connected to the first voltage VDD, a right terminal of the second capacitor C2 is connected to the gate of the first TFT T1, and after the first stage, the gate of the first TFT T1 has a voltage VI. In the second stage, the first voltage VDD charges the gate of the first TFT T1 through the first TFT T1 and the fourth TFT T4 until the voltage of the gate of the first TFT T1 rises up to VDD−|Vth|. Wherein, Vth is a threshold voltage of the first TFT T1. At this time, the voltage level at right terminal of the second capacitor C2 is VDD−|Vth|, and the voltage level at the left terminal of the second capacitor C2 is still VDD so that a voltage difference between the two terminals of the second capacitor C2 is |Vth|. Accordingly, the second capacitor C2 will record a voltage value of the threshold voltage Vth of the first TFT T1.

The third stage is a data signal writing stage. In the third stage, the third control signal S3 is set at a low voltage level, the first control signal S1, the second control signal S2 and the light-emitting control signal EM are set at a high voltage level. The second TFT T2 and the first TFT T1 are conductive, and the other TFTs are turned off. After the second TFT T2 is conductive, the data voltage Vdata is outputted to the drain of the second TFT T2. The left terminal of the second capacitor C2 is connected to the drain of the second TFT T2 so that the voltage level becomes Vdata. According to a charge conservation principle, the voltage level at the right terminal of the second capacitor C2 jumps to Vdata−|Vth|. In the third stage, the first capacitor C1 will also record the signal of Data.

The fourth stage is a light-emitting stage. In the fourth stage, the light-emitting signal EM is set at a low voltage level, the first control signal to the third control signal S1˜S3 are set at a high voltage level. The first TFT T1 and the sixth TFT T6 are conductive, and the other TFTs are turned off. At this time, the voltage level of the source of the first TFT T1 is VDD, the voltage level of the gate of the first TFT T1 is Vdata−|Vth| so that a driving current of the organic light-emitting diode of the first TFT T1 is: I_{OLED}−k(V_{GS}−|Vth|)²=k(VDD−(Vdata−|Vth|)−|Vth|)²=k(VDD−Vdata)² , wherein, k is a current amplification coefficient of the first TFT T1.

Accordingly, the driving current of the OLED is unrelated to the threshold voltage Vth of the first TFT T1. Accordingly, the present invention can eliminate a bad display problem of the AMOLED caused by the drift of the threshold voltage of the first TFT T1.

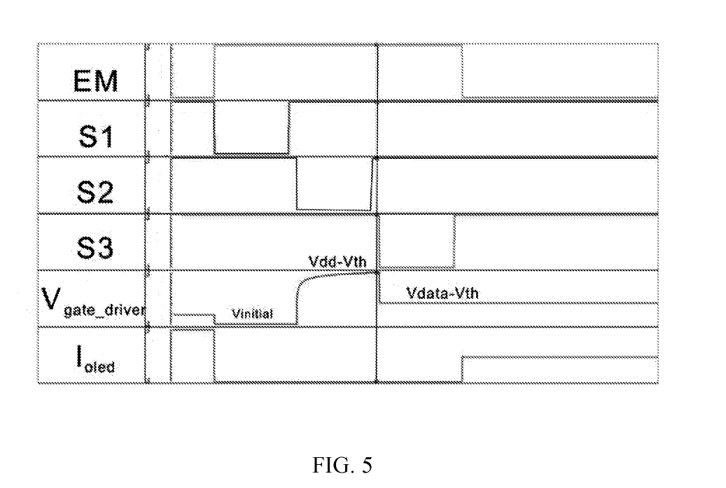

FIG. 5 is a simulation result of the pixel circuit according to an embodiment of the present invention. From FIG. 5, the driving current I_{OLED} of ii the OLED is stable without being affected by the drift of the threshold voltage of the driving TFT T1.

The present invention also provides a driving method for the above pixel circuit, and the method comprises a reset stage, a compensation stage for the threshold voltage, a data signal writing stage and a light-emitting stage.

In the reset stage, the first control signal S1 is set at a low voltage level, the resetting module outputs the reset voltage VI to the compensation module 02 under the control of the first control signal S1; in a compensation stage for the threshold voltage, setting the second control signal S2 at a low voltage level, the compensation module 02 records the threshold voltage under the control of the second control signal S2; in the data signal writing stage, the third control signal S3 is set at a low voltage level, the writing module 03 outputs the data voltage Vdata to the compensation module 02 under the control of the third control signal S3; in the light-emitting stage, the light-emitting control signal EM is set at a low voltage level, the light-emitting module 04 emits light under the control of the light-emitting control signal EM.

Specifically, in the reset stage, setting the first control signal S1 at a low voltage level so that the fifth TFT is conductive, and the reset voltage VI is outputted through the drain of the fifth TFT T5, and the gate of the first TFT T1 is reset to be the reset voltage VI; in a compensation stage for the threshold voltage, setting the second control signal S2 at a low voltage level, and the first TFT T1, the third TFT T3and the fourth TFT T4 are conductive, wherein the first voltage VDD charges the gate of the first TFT T1 through the first TFT Ti and the fourth TFT T4 until the voltage of the gate of the first TFT T1 rises up to VDD−|Vth|, ii and the second capacitor C2 records a voltage value of the threshold voltage of the first TFT T1; in the data signal writing stage, setting the third control signal S3 at a low voltage level so that the second TFT T2 is conductive, after the second TFT T2 is conductive, the data voltage Vdata is outputted to the drain of the second TFT T2, the first capacitor C1 records the data voltage Vdata, the voltage at the gate of the first TFT T1 becomes Vdata−|Vth| through the second capacitor C2; in the light-emitting stage, setting the light-emitting control signal EM at a low voltage level, the first TFT T1 and the sixth TFT T6 are conductive, and the organic light-emitting diode emits light. At this time, a driving current of the organic light-emitting diode of the first TFT T1 is: I_{OLED}=k(V_{GS}−|Vth|)²=k(VDD−(Vdata−|Vth|)−|Vth|)²=k(VDD−Vdata)², wherein, k is a current amplification coefficient of the first TFT T1. From above formula, the driving current of the OLED is unrelated to the threshold voltage Vth of the first TFT T1.

In the driving method for pixel circuit provided by the embodiment of the present invention, through the resetting stage to realize the resetting of the gate of the first TFT T1, through the compensation stage for threshold voltage to record the threshold voltage of the first TFT T1, through writing the data signal to drive the light-emitting device to emit light in the light-emitting stage. Wherein, the compensation stage for the threshold voltage can record the threshold voltage of the first TFT T1 so that in the following writing and light-emitting stages, the affection of the threshold voltage can be canceled so as to output a stable driving current.

It can be understood that the exemplary embodiments described here should only be considered as a descriptive meaning, not for the purpose of limiting. The description of features or aspects in each exemplary embodiment should be considered to be capable of applying in similar features or aspects in other exemplary embodiments.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A pixel circuit, comprising:
a resetting module, wherein a control terminal of the resetting module receives a first control signal, the other two terminals of the resetting module are respectively connected to a reset voltage terminal and the compensation module, the reset voltage terminal has a reset voltage, the resetting module transmits the reset voltage to the compensation module under the control of the first control signal;
a compensation module, wherein the compensation module receives a second control signal and a first voltage from a first voltage terminal, the compensation module is respectively connected to the resetting module, the writing module and the light-emitting module, the compensation module performs compensation for a threshold voltage under the control of the second control signal;
writing module, wherein a control terminal of the writing module receives a third control signal, an input terminal of the writing module is connected with a data signal terminal and receives a data signal from the data signal terminal, an output terminal of the writing module is connected to the compensation module, the writing module transmits the data signal to the compensation module under the control of the third control signal; and
a light-emitting module, wherein a terminal of the light-emitting module is connected to a second voltage terminal and receives a second voltage from the second voltage terminal, another terminal of the light-emitting module is connected to the compensation module, a control terminal of the light-emitting module receives a light-emitting control signal, the light-emitting module emits light under the control of the light-emitting control signal.

2. The pixel circuit according to claim 1, wherein, the resetting module includes a fifth TFT, a gate of the fifth TFT receives the first control signal, a drain of the fifth TFT is connected to the compensation module, a source of the fifth TFT receives the reset voltage VI, and the fifth TFT outputs the reset voltage to the compensation module under the control of the first control signal.

3. The pixel circuit according to claim 2, wherein, the compensation module includes a first TFT, a third TFT, a fourth TFT, a first capacitor and a second capacitor; a gate of the first TFT is connected to the resetting module, a source of the first TFT receives a first voltage, a drain of the first TFT is connected to the light-emitting module; a gate of the third TFT receives the second control signal, a source of the third TFT receives the first voltage, and a drain of the third TFT is connected to the writing module; a gate of the fourth TFT is connected to the second control signal, a source and a drain of the fourth TFT are respectively connected to a drain and a gate of the first TFT; two terminals of the first capacitor are respectively connected to the first voltage terminal and the writing module; two terminals of the second capacitor are respectively connected to the writing module and the gate of the first TFT; under the control of the second control signal, the first TFT, the third TFT, and the fourth TFT are conductive, and the second capacitor records a threshold voltage Vth of the first TFT.

4. The pixel circuit according to claim 3, wherein, the writing module includes a second TFT; a gate of the second TFT receives the third control signal, a source of the second TFT is connected to the data input terminal, and a drain of the second TFT is connected to the compensation module; the second TFT is conductive under the control of the third control signal, and outputs a data voltage of the data signal to the compensation module.

5. The pixel circuit according to claim 4, wherein, the light-emitting module includes a sixth TFT and an organic light-emitting diode; a gate of the sixth TFT receives the light-emitting control signal, a source of the sixth TFT is connected to the compensation module, a drain of the sixth TFT is connected to the organic light-emitting diode; one terminal of the light-emitting diode is connected to the drain of the sixth TFT, and the other terminal of the light-emitting diode is connected to the second voltage terminal; under the control of the light-emitting control signal, the sixth TFT is conductive so that the organic light-emitting diode is conductive to emit light.

6. The pixel circuit according to claim 1, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

7. The pixel circuit according to claim 2, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

8. The pixel circuit according to claim 3, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

9. The pixel circuit according to claim 4, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

10. The pixel circuit according to claim 5, wherein, each of the reset voltage and the second voltage is at a low voltage level, the first voltage is at a high voltage level; each of the first TFT, the second TFT, the third TFT, the fourth TFT, the fifth TFT and the sixth TFT is a P-type TFT.

11. A driving method for a pixel circuit, wherein the pixel circuit has a pixel circuit as claimed in claim 5, and the driving method comprises:
in a reset stage, setting the first control signal at a low voltage level so that the fifth TFT is conductive, and the fifth TFT outputs the reset voltage to the gate of the first TFT, and the gate of the first TFT is reset to be the reset voltage;
in a compensation stage for the threshold voltage, setting the second control signal at a low voltage level, and the first TFT, the third TFT and the fourth TFT are conductive, wherein the first voltage charges the gate of the first TFT through the first TFT and the fourth TFT until the voltage of the gate of the first TFT rises up to VDD−|Vth|, and the second capacitor records a voltage value of the threshold voltage of the first TFT, wherein VDD is the first voltage and Vth is the threshold voltage of the first TFT;
in a data signal writing stage, setting the third control signal at a low voltage level so that the second TFT is conductive, the data voltage is outputted through the drain of the second TFT, the first capacitor record the data voltage, the voltage at the gate of the first TFT becomes Vdata-1Vth1 through the second capacitor, wherein Vdata is the data voltage; and
in a light-emitting stage, setting the light-emitting control signal at a low voltage level, the first TFT and the sixth TFT being conductive, and the organic light-emitting diode emitting light.

12. The driving method according to claim 11, wherein the reset voltage and the second voltage are at a low voltage level, and the first voltage is at a high voltage level.

13. An organic light-emitting display having a pixel circuit as claimed in claim 1.
